(19) United States
(12) Patent Application Publication
(10) Pub. No.: US 2023/0017467 A1
(43) Pub. Date: Jan. 19, 2023

(54) A POLYURETHANE COMPOSITION HAVING LOW TOTAL VOC CONTENT CAPABLE OF RAPID CURING WITH NO NEED OF PRIMER

(71) Applicant: SIKA TECHNOLOGY AG, Baar (CH)

(72) Inventors: Junjie YANG, Suzhou (CN); Xiaoyan ZHANG, Suzhou (CN)

(73) Assignee: SIKA TECHNOLOGY AG, Baar (CH)

(21) Appl. No.: 17/780,394

(22) PCT Filed: Dec. 3, 2020
(86) PCT No.: PCT/CN2020/133486

§ 371 Date: May 26, 2022

(30) Foreign Application Priority Data
Dec. 3, 2019 (CN) 201911220008.8

(51) Int. Cl. C08L 75/08; C09J 175/08; C08G 18/10; C08G 18/76; C08G 18/20; C08G 18/48; C08G 18/24; C08G 18/42; C08G 18/28; C08G 18/12

(52) U.S. Cl. CPC C08L 75/08; C09J 175/08; C08G 18/10; C08G 18/7671; C08G 18/2027; C08G 18/4829; C08G 18/4841; C08G 18/4825; C08G 18/246; C08G 18/42; C08G 18/7621; C08G 18/289; C08G 18/12; C08L 2205/02

(57) ABSTRACT

A polyurethane composition includes, based on the total weight of the composition, A) 20-35 wt % of polyurethane prepolymer PU-1 which is a reaction product of ethylene oxide (EO)-terminated polyether triol with an aromatic polyisocyanate, and B) 0.2-3 wt % of polyurethane prepolymer PU-2 which is a reaction product of polyester polyol with an aromatic polyisocyanate. The composition has a low TVOC content, has a good adhesion without the need of primer, can cure rapidly with a high initial bonding strength, while keeping good mechanical properties.

### TECHNICAL FIELD

The present invention relates to the field of polyurethane compositions. The inventive compositions are particularly suitable for bonding and sealing applications in the industrial manufacture and in automobiles production and repair, particularly suitable for adhesive bonding, for example, windshield.

### PRIOR ART

Polyurethane-based adhesives have a long history of use in industrial manufacture, as for example for the elastic bonding and sealing of glass sheets in the production and repair of vehicles such as automobiles, trucks, trains, or boats. Particularly in the case of rapid bonding operations, where the adhesive bond must be quick, because the bond will be loaded soon after the substrates are assembled, said substrates are typically pretreated, with a primer for example, in order to support the development of adhesion between substrate and adhesive. The pretreatment, though, constitues an additional, time-consuming workstep, which incurs costs and increases the complexity and hence susceptibility to error of the bonding operation. In order to reduce costs and to increase operational reliability, therefore, there is a strong desire for adhesives which reliably and very rapidly develop effective adhesive force even to substrates which have not been pretreated by primer.

One simple means of enhancing the development of adhesion of an adhesive to the substrate is to admix it with an adhesion promoter which is effective on the substrate in question. For example, CN1995256A discloses a primer-free one-component moisture curable polyurethane adhesive which can be used in auto manufacturing industry for assembling auto window glasses and windshields. Such polyurethane adhesive composition comprises polyurethane prepolymer, an adhesion promoter, and particularly 2,2-dimorpholine diethyl ether and dibutyltin dilaurate catalyst, wherein the adhesion promoter is an adduct of silane coupling agent and polyurethane prepolymer. However, this patent concerns the function of an adhesion promoter and a large amount of solvent is used when preparing the adhesive. Although the solvent will contribute to an effective bonding, it is environmentally unfriendly, resulting in a very high total VOC content which is very unhealthy to operators.

Moreover, CN104449534A discloses a primer-free polyurethane glass glue having a complex composition. But this document fails to disclose any data regarding anti-sliding and initial bonding strength properties, which are important to consumers.

Solvents are widely comprised in prior art adhesive compositions. However, it is usually difficult for solvent free products having high modulus to achieve a good adhesion with no aid of a primer, because these products have a lower wetting ability and a lower polarity in comparison with products comprising a solvent.

### SUMMARY OF THE INVENTION

In view of these problems in the prior art, a polyurethane composition suitable for bonding applications and sealing applications in the industrial manufacture and in automobile production and repair is desired, which should contain as less as possible or even no solvent, thereby resulting in a low TVOC content, have good adhesion without the need of primer, rapidly cure with a high initial bonding strength meanwhile keeping good mechanical properties such as tensile strength and elongation at break, as well as excellent extrudability and workability. Said polyurethane composition is particularly suitable for elastic bonding and sealing of, for example glass sheets in vehicle production and repair, without a compulsory aid of an activator or primer to pretreat the glass sheets.

The inventors of the present invention have surprisingly found that the composition according to claim 1 can achieve the aforementioned purposes.

In particular, the composition according to the present invention can achieve a rapid curing with good mechanical properties, and meanwhile a good adhesion without use of an undercoat or a primer.

Further aspects of the invention are subjects of further independent claims. Particularly preferred embodiments of the invention are subjects of the dependent claims.

### DETAILED DESCRIPTION OF THE INVENTION

The subject matter of the present invention is a polyurethane composition, comprising, based on the total weight of the composition,

A) 20-35 wt %, preferably 23-32 wt % of polyurethane prepolymer PU-1 which is a reaction product of ethylene oxide (EO)-terminated polyether triol with an aromatic polyisocyanate, and

B) 0.2-3 wt %, preferably 0.3-2.5 wt %, such as 1.0-2.2 wt % of polyurethane prepolymer PU-2 which is a reaction product of polyester polyol with aromatic polyisocyanate.

The inventors of the present invention have found that an excellent bonding, a rapid curing and a high initial bonding strength while keeping satisfactory mechanical properties can be achieved without the aid of a primer by using the combination of two different types of polyurethane PU-1 and PU-2 as described above in the polyurethane compositions in the above mentioned specific amount range. Moreover, it is also possible to omit solvent in the polyurethane composition of the present invention, so as to lower total VOC content.

Substance names beginning with “poly”, such as polyol, polyisocyanate or polyurethane, in the present document identify substances which formally contain two or more per molecule of the functional groups that occur in their name. For example, polyol refers to substances with two or more hydroxyl groups.

Isocyanate terminated polymers are polymers or prepolymers having at least one isocyanate end group, particularly two isocyanate end groups.

In the context of the present invention, EO terminated polymers (such as polyethers or polyether triols) are also known as ethylene oxide terminated polymers, which are polymers or prepolymers having at least one, particularly two, three or more ethylene oxide end groups (EO groups).

The term “prepolymers” herein generally refer to oligomers or polymers which are used as intermediate products for producing higher molecular weight polymers.

“Molecular weight” is understood in the present document to refer to the molar mass (in grams per mole) of a molecule. “Average molecular weight” means the number average Mn of an oligomeric or polymeric mixture of molecules, and is customarily determined by means of gel permeation chromatography (GPC) against polystyrene as standard. “Room temperature” in the present document refers to a temperature of 23° C.

The term “polyurethane polymer/prepolymer” encompasses all polymers or prepolymers which are prepared by the process known as the diisocyanate polyaddition process. This also includes those polymers or prepolymer virtually free or entirely free from urethane groups. Examples of polyurethane polymers/prepolymer are polyether-polyurethanes, polyester-polyurethanes, polyether-polyureas, polyureas, polyester-polyureas, polyisocyanurates, and polycarbodiimides.

The first polyurethane prepolymers PU-1 according to the present invention are prepolymers obtained from the reaction of EO terminated polyether triols with aromatic polyisocyanates. Herein, the inventors have found that polyether triols are preferred to polyether diols or other polyether polyols in view of reaction activities, mechanical properties of the products and the technical effects of the present invention.

Polyether polyols (also known as polyoxyalkylene polyols or lower polyether alcohols) particularly suitable as EO terminated polyether triols are those which are polymerization products of ethylene oxide, 1,2-propylene oxide, 1,2- or 2,3-butylene oxide, oxetane, tetrahydrofuran, or mixtures thereof, optionally polymerized with the aid of a starter molecule having two or more active hydrogen atoms, such as water, ammonia, for example, or compounds having two or more OH or NH groups, such as, for example, 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, bisphenol A, hydrogenated bisphenol A, 1,1,1-trimethylolethane, 1,1,1-trimethylolpropane, glycerol, aniline, and also mixtures of the stated compounds. Use may be made both of polyoxyalkylene polyols which have a low degree of unsaturation (measured by ASTM D 2849-69 and expressed in milliequivalents of unsaturation per gram of polyols (meq/g)), prepared for example by means of double metal cyanide complex catalysts (DMC catalysts), and of polyoxyalkylene polyols having a higher degree of unsaturation, prepared for example by means of anionic catalysts such as NaOH, KOH, CsOH, or alkali metal alkoxides.

Particularly suitable are polyoxyalkylene triols, preferably for example, polyoxyethylene triols and polyoxypropylene triols, and polyoxyethylene polyoxypropylene triols. Moreover, preferable are polyoxyalkylene triols having a degree of unsaturation of less than 0.02 meq/g and having a molecular weight in the range from 1000 to 30,000 g/mol, and more preferable are polyoxyethylene triols, polyoxypropylene triols and polyoxyethylene polyoxypropylene triols having a molecular weight in the range from 400 to 20000 g/mol, preferably 2000 to 10000 g/mol, more preferably 4000 to 6000 g/mol.

Those polyether polyols other than said EO terminated polyether triols as mentioned below may be also suitably selected from these polyether polyols.

The preparation of EO terminated polyether triols is known to the skilled in the art. In an exemplary embodiment, an alkaline catalyst such as KOH can be used to firstly prepare polyethers having low molecular weight (such as about 500 g/mol) as starting materials, which are refined and then formed into propylene oxide based polyethers of a high molecular weight in a reaction vessel by continuously feeding propylene oxides in the presence of a DMC catalyst at a temperature of, for example, 130 to 150° C. At last, ethylene oxides are fed in at a temperature of about 100 to 110° C. to produce the final desired EO terminated polyether triols. If necessary, the final EO terminated polyether triols can be further worked up.

Furthermore, for example, the above produced EO terminated polyether triols and aromatic polyisocyanates can be reacted at a temperature of 50° C. to 85° C., wherein the aromatic polyisocyanates are metered so that the free isocyanate groups are present in excess over hydroxyl groups of polyols. Particularly, an excessive amount of aromatic polyisocyanates is chosen to remain 0.1 to 5 wt %, preferably 0.2 to 3 wt %, particularly preferably 0.3 to 2.5 wt % of free isocyanate groups in the obtained polyurethane polymers after all hydroxyl groups of polyols are reacted, on the basis of the overall polymers.

In the composition according to the present invention, another essential polyurethane prepolymer is polyurethane prepolymers PU-2 obtained from reactions between polyester polyols, preferably polyester diols, and aromatic polyisocyanates.

The preparation of polyurethane prepolymers PU-2 is also known by the skilled in the art. In one embodiment, the component comprising polyester diols can be reacted with aromatic polyisocyanates at, for example, a temperature of 50° C. to 100° C., wherein the aromatic polyisocyanates are metered so that the free isocyanate groups are present in a stoichiometric excessive amount over hydroxyl groups in polyols.

Particularly, an excessive amount of polyisocyanates is chosen to remain 0.1 to 5 wt %, preferably 0.2 to 3 wt %, particularly preferably 0.3 to 2.5 wt % of free isocyanate groups in the obtained polyurethane prepolymers after all hydroxyl groups of polyols are reacted, on the basis of overall polymers.

Optionally, polyurethane prepolymers PU-1 and PU-2 each can be produced under simultaneously using a plasticizer, wherein the plasticizer used does not comprise groups reactive to isocyanates.

Preferably, polyurethane prepolymers PU-1 or PU-2 having said free isocyanate group content are obtained through the reaction of polyisocyanates (preferably diisocyanates) with high molecular weight polyols at a NCO:OH-ratio of 1.3:1 to 4:1, particularly is1.5:1 to 3:1 and particularly preferably 1.7:1 to 2.5:1.

Herein, especially suitable as polyester polyols are polyesters which carry at least two hydroxyl groups and are prepared by known processes, particularly by the polycondensation of hydroxycarboxylic acids or the polycondensation of aliphatic and/or aromatic polycarboxylic acids with dihydric or polyhydric alcohols. Preferably, the polyester polyols have a molecular weight of 1000 to 6000 g/mol, more preferably 1500 to 4000 g/mol or 2000 to 3500 g/mol. Moreover, the polyester polyols are also preferably hydrophobic.

Especially suitable are polyester polyols prepared from dihydric to trihydric alcohols such as, for example, 1,2-ethanediol, diethylene glycol, 1,2-propanediol, dipropylene glycol, 1,4-butanediol, 1,5-pentanediol, 1,6-hexanediol, neopentyl glycol, glycerol, 1,1,1-trimethylolpropane, or mixtures of the aforementioned alcohols, with organic dicarboxylic acids or their anhydrides or esters, such as, for example, succinic acid, glutaric acid, adipic acid, trimethyladipic acid, suberic acid, azelaic acid, sebacic acid, dodecanedicarboxylic acid, maleic acid, fumaric acid, dimer fatty acid, phthalic acid, phthalic anhydride, isophthalic acid, terephthalic acid, dimethyl terephthalate, hexahydrophthalic acid, trimellitic acid and trimellitic anhydride, or mixtures of the aforesaid acids, and also polyester polyols of lactones such as s-caprolactone, for example.

Particularly suitable are polyester diols, especially those prepared from adipic acid, azelaic acid, sebacic acid, dodecanedicarboxylic acid, dimer fatty acid, phthalic acid, isophthalic acid, and terephthalic acid as dicarboxylic acid or from lactones such as, for example, s-caprolactone and from ethylene glycol, diethylene glycol, neopentyl glycol, 1,4-butanediol, 1,6-hexanediol, dimer fatty acid diol, and 1,4-cyclohexanedimethanol as dihydric alcohol.

As the polyisocyanates used for preparing the polyurethane prepolymers according to the present invention, aromatic polyisocyanates are preferably used, in particular aromatic diisocyanates. Comparing with aliphatic polyisocyanates, aromatic polyisocyanates, in particular diisocyanates, are more advantageous in terms of high mechanical properties.

Therefore, the aromatic polyisocyanates is preferably a diisocyanate which is preferably selected from m- and p-xylylene diisocyanate (m- and p-XDI), m- and p-tetramethyl-1,3-xylylene diisocyanate, m- and p-tetramethyl-1,4-xylylene diisocyanate, bis(1-Isocyanato-1-methylethyl)naphthalene, 2,4- and 2,6-tolylene diisocyanate (TDI), 4,4′-, 2,4′- and 2,2′-diphenylmethane diisocyanate (MDI), 1,3- and 1,4-phenylene diisocyanate, 2,3,5,6-tetramethyl-1,4-diisocyanatobenzene, naphthalene 1,5-diisocyanate (NDI), 3,3′-dimethyl-4,4′-diisocyanatodiphenyl (TODI), oligomers and mixtures of the aforesaid isocyanates. It has been found, when 4.4′-, 2,4′- and 2,2′-diphenylmethane diisocyanates (MDI) and mixtures thereof are particularly preferred as the aromatic diisocyanates, higher mechanical properties, in particular the increased initial bonding strength of the adhesives, and a higher adhesion as well as aging resistance can be achieved, meanwhile helpful for increasing the reactivity of adhesives.

In the composition according to the present invention, based on the total weight of the composition, polyurethane prepolymers PU-1 are preferably present at an amount of 23 to 32 wt %, and polyurethane prepolymers PU-2 are preferably present at an amount of 0.3 to 2.5 wt % or 1.0 to 2.2 wt %.

According to the present invention, if the amount of polyurethane prepolymers PU-1 is less than 20 wt %, the mechanical properties of the resulting adhesives could be low and anti-aging properties could be poor; while if it is more than 35 wt %, there could be a risk that the bonding force is less than cohesion force. In another aspect, less than 0.2 wt % of the polyurethane prepolymers PU-2 could result in that the anti-sliding ability and workability of the product are adversely affected, such as drawing; while an amount of more than 3 wt % could result in that the obtained adhesives are difficult to be applied.

The composition of the invention can further comprise at least one silane adhesion promoter. These are individual or mixed organoalkoxysilanes which possess at least one nonhydrolyzable organic radical on the silicon atom, this radical preferably containing heteroatoms which are able—by way of free electron pairs, covalent, ionic or other mechanisms—to develop interaction with a substrate and thus to develop adhesion to that substrate. “Nonhydrolyzable” in this context means a silicon-carbon bond, in contrast, for example, to a hydrolyzable silicon-oxygen bond. In the case of bond substrates containing silicon oxide, such as glasses, the silane group of the organoalkoxysilane may also, through a hydrolysis/condensation reaction, mediate covalent adhesion to the substrate, while the organic radical reacts with the adhesive composition, by way, for example, of reaction of any hydroxyl or amine group present with an isocyanate group of a polyurethane polymer.

Suitable silane adhesion promoters are organoalkoxysilanes (“silanes”), which carry a reactive group on the organic radical, more particularly epoxysilanes, mercaptosilanes, (meth)acrylosilanes, isocyanatosilanes, anhydridosilanes, S-(alkylcarbonyl)mercaptosilanes, aldiminosilanes, or oligomeric forms of these silanes, or adducts of amino- or mercaptosilanes with polyisocyanates. Preferred are 3-glycidyloxypropyltrimethoxysilane, β-(3,4-epoxycyclohexyl)ethyltrimethoxysilane, 3-mercaptopropyltrimethoxysilane, or 3-methacryloyloxypropyltrimethoxysilane. The most preferred is 3 glycidyloxypropyltrimethoxysilane.

The amount of silane adhesion promoter in the composition is preferably in the range from 0.01 wt % to 1.0 wt %, more particularly 0.05 wt % to 0.5 wt %, based on the total weight of the composition.

The use of a silane adhesion promoter in accordance with the invention affords the advantage that the development of adhesion to the substrate by the adhesive is improved without any need for the substrate to be pretreated with primer or activator beforehand. This is especially advantageous in the context of glass and ceramic glass as the substrates.

The composition preferably comprises at least one metal catalyst. This catalyst may either be added additionally, or already be present in the raw materials of the composition—for example, from the synthesis of a polyurethane polymer containing isocyanate groups. Preferred as metal catalyst are organotin (IV) compounds, organotitanates or organozirconates. Particularly preferred are organotin (IV) compounds. Suitability as organotin (IV) compound is possessed in particular by dialkyltin oxides, dialkyltin dichlorides, dialkyltin dicarboxylates, and dialkyltin diketonates, preferably dibutyltin oxide, dibutyltin dichloride, dibutyltin diacetate, dibutyltin dilaurate, dibutyltin diacetylacetonate, dioctyltin oxide, dioctyltin dichloride, dioctyltin diacetate, dioctyltin dilaurate, or dioctyltin diacetylacetonate.

The amount of metal catalyst in the composition is preferably in the range from 0.001 wt % to 1.0 wt %, more particularly 0.005 wt % to 0.1 wt %, based on the total weight of the composition.

The amount of any organotin (IV) compound possibly used in the composition is preferably in the range from 0.001 wt % to 0.2 wt %, more particularly 0.005 wt % to 0.1 wt %, based on the total weight of the composition.

The composition described preferably comprises further ingredients customary for polyurethane adhesives, especially fillers, plasticizers, rheological additives, adhesion promoters, drying agents or stabilizers with respect to UV light and oxidation, and also further common adjuvants of these kinds.

In particular the composition comprises at least one filler. Suitability as filler is possessed in particular by natural, ground or precipitated chalks (which consist entirely or primarily of calcium carbonate), which are optionally coated with fatty acids, more particularly stearates; barium sulfate (BaSO₄, also called barite or heavy spar); calcined kaolins; aluminum oxides; aluminum hydroxides; silicas, more particularly finely divided silicas from pyrolysis processes; carbon blacks, especially industrially produced carbon black; PVC powders; or hollow beads. Preferred fillers are calcium carbonates, calcined kaolins, carbon black, finely divided silicas, and flame-retardant fillers, such as hydroxides or hydrates, especially hydroxides or hydrates of aluminum, preferably aluminum hydroxide.

It is entirely possible and may even be of advantage to use a mixture of different fillers. Particularly preferred fillers are ground calcium carbonates, calcined kaolins, or carbon black. Most preferred are combinations of ground calcium carbonates or calcined kaolins and carbon black.

The amount of filler in the composition is preferably in the range from 10 wt % to 70 wt %, more particularly 20 wt % to 60 wt %, such as 30 wt % to 50 wt %, based on the total weight of the composition.

The composition in particular comprises at least one plasticizer. Especially suitable as plasticizers are esters of organic carboxylic acids, more particularly phthalates such as diisononyl phthalate or diisodecyl phthalate, hydrogenated phthalates such as diisononyl 1,2-cyclohexanedicarboxylate, adipates such as dioctyl adipate, azelates and sebacates, or esters of organic phosphoric and sulfonic acids, or hydrocarbons such as polybutenes or polyisobutenes. Preferred plasticizers are phthalates, hydrogenated phthalates or adipates. Most preferred are diisononyl phthalate, diisodecyl phthalate or diisononyl 1,2-cyclohexanedicarboxylate.

The amount of plasticizer in the composition is preferably in the range from 5 wt % to 40 wt %, more particularly 10 wt % to 30 wt %, very preferably 15 wt % to 25 wt %, based on the total weight of the composition. Furthermore, as mentioned above, the composition of the invention may additionally comprise other ingredients customary for polyurethane adhesives. Such ingredients are, by way of example:
crosslinkers, such as, for example, oligomers and derivatives of diisocyanates such as MDI, TDI, HDI or IPDI, especially isocyanurates, carbodiimides, uretonimides, biurets, allophanates, and iminooxadiazinediones, or mixtures of MDI and MDI homologs (polymeric MDI or PMDI);
drying agents, such as, for example, p-tosyl isocyanate and other reactive isocyanates, calcium oxide, or molecular sieves;
rheological modifiers such as, for example, thickeners, examples being urea compounds of the kind described as thixotroping agents (“thixotropy endowning agent”) in WO 02/48228 A2 on pages 9 to 11, polyamide waxes, bentonites, or fumed silicas;
stabilizers against heat, light and UV radiation; flame retardants;
surface-active substances such as, for example, wetting agents, flow control agents, deaerating agents or defoamers;
biocides such as, for example, algicides or fungicides;

and also further substances customarily used in one-component isocyanate-containing compositions, such as, for example, fibers, as for example of polyethylene; dyes, pigments, or other adjuvants known to the person skilled in the art.

Particularly, in one advantageous embodiment, the composition of the present invention may further comprise reaction products of non-EO terminated polyether diols and polyether triols with aromatic polyisocyanates which are different from above said polyurethane prepolymers PU-1 in an amount of no more than 20 wt %, such as 15 wt % or 10 wt %, to further improve mechanical properties, in particular flexibility. In one preferable embodiment, TDI prepolymers are used, which are reaction products of polyether diols and polyether triols with TDI. Preferably, in the TDI prepolymers, the polyether diols have a molecular weight ranging from 2800 to 4500 g/mol and the polyether triols have a molecular weight ranging from 3500 to 6000 g/mol. Further preferably, in this preparation, the polyether diols and polyether triols are used at a weight ratio of 1.5:1 to 3:1. Suitable polyether polyols here are as those described above, but preferably are not above said EO terminated polyether polyols. Preferably, for example, PO terminated (i.e., propylene oxide terminated) polyether polyols can be used.

Moreover, in order to further improve the viscosity of the polyurethane prepolymers PU-2, one or more reaction products of PO terminated polyether diols and aromatic polyisocyanates can be preferably added individually or together thereto. The amount of the PO terminated polyether diols is no more than 25%, such as 20% or 15% based on the total weight of polyols in the polyester diols of PU-2 and the PO terminated polyether diols. In one exemplary embodiment, in the preparation of PU-2, a suitable amount of PO terminated polyether diols and polyester diols can be added together into a reaction vessel, and then the mixture and aromatic polyisocyanates are subject to reactions together. Also, a suitable amount of separately prepared reaction products of PO terminated polyether diols with aromatic polyisocyanates can be added together with the addition of PU-2. In this case, polyether diols suitable as the PO terminated polyether diols are those mentioned above for EO terminated polyether diols. Aromatic polyisocyanates are also preferably those described above, and more preferably the same as aromatic polyisocyanates used for PU-2.

In another advantageous embodiment, the composition comprises, based on the total weight of the composition, less than 1 wt %, preferably less than 0.5 wt %, more preferably less than 0.1 wt % of organic solvent, particularly organic solvent such as ketones, aromatic hydrocabons, dimethyl formamide, tetrahydrofuran etc.

The composition of the present invention is suitable, for example, as an adhesive for bonding and sealing glass or screen-printed ceramics, in the context, for example, of vehicle construction or vehicle repair in the bonding of glass sheets.

Under the influence of moisture, optionally accelerated by heating, the composition of the invention cures rapidly, with crosslinking of the polyurethane prepolymers PU-1 and PU-2 and any crosslinkers and/or latent ones present. The moisture that is needed for curing may come from the air (atmospheric moisture), in which case the composition cures from the outside inward through the diffusion of the moisture. Alternatively, a water-containing component, for example, in the form of a water-containing paste, may be added to the composition. The water-containing paste is homogeneously or heterogeneously with the composition by, for example, a static mixer.

The composition of the invention possesses a long shelf life, meaning that it is storage-stable for a relatively long time. A composition is referred to as “storage-stable” or “storable” if it can be kept at room temperature in a suitable container for a relatively long time, typically at least 3 months up to 6 months or more, without suffering any change in its application or usage properties, particularly the viscosity, the required extrusion force on application from the container, and the crosslinking rate, to an extent relevant for its usage, as the result of the storage process. This means, for example, that for the composition of the invention, the extrusion force, measured by the method described below at 23° C., after storage at 60° C. for 14 d (which produces accelerated aging), increases preferably by a factor of not more than 3, more preferably not more than 2.5, more particularly not more than 2, in comparison to the extrusion force of a freshly prepared composition stored at 23° C. for 7 d.

The present invention further encompasses the use of an above-described composition as a moisture-curing adhesive or sealant. The composition of the invention is suitable especially for application to concrete, mortar, brick, tile, plaster, a natural stone such as granite or marble, glass, glass-ceramic, screen-printed ceramic, a metal or a metal alloy, wood, a plastic, or a painted material.

The composition is used preferably as adhesive or sealant, for glass, glass-ceramic or screen-printed ceramic, for example.

The composition according to the present invention preferably has a paste thickness having a structural viscous property. The composition can be applied via a glue gun or a pumping system or be squeezed out through a suitable glue nozzle.

Therefore, another aspect of the present invention relates to a method of bonding substrates, including:
a) Applying the inventive composition as described above to a first substrate;
b) Providing a second substrate on which the inventive composition as described above is optionally applied; and
c) Contacting the first and second substrate;

wherein the first and second substrates are made from the same or different materials. Preferably, the first substrate and second substrate are identically or differently selected from glass, ceramic and transportation vehicles and the components thereof, preferably windows of the automobile.

The present invention also relates to a cured composition obtained from the above said composition upon moisture (particularly in the form of air moisture) curing.

The articles bonded and/or sealed with a composition of the invention comprise, in particular, an edifice, more particularly an edifice in structural or civil engineering, an industrially manufactured product or a consumer product, more particularly a window, a household appliance, or a means of transport or ancillary component of a means of transport, more particularly a glass sheet.

### Examples

Set out below are working examples which are intended to elucidate in more detail the invention described. The invention is of course not confined to these working examples described.

Description of Measurement Methods

The tensile strength and the elongation at break were determined according to DIN EN ISO 527 (tensioning rate: 200 mm/min) on films with a layer thickness of 2 mm that have been cured for 7 days (d) at 23° C. (room temperature, “RT”) and 50% relative humidity.

For the determination of the extrusion force the compositions were dispensed into internally coated aluminum cartridges (outer diameter 46.9 mm, inner diameter 46.2 mm, length 215 mm, metric ISO thread M15×1.5 mm) and given an airtight seal with a polyethylene stopper (diameter 46.1 mm) from Novelis Germany GmbH. After conditioning at 23° C. for 24 hours, the cartridges were opened and the contents extruded using an extrusion device. For this purpose, a nozzle with a 5 mm inside-diameter opening was screwed onto the cartridge thread. Using an extrusion device (Zwick/Roell Z005), a determination was made of the force needed to extrude the composition at an extrusion rate of 60 mm/min. The figure reported is an average value of the forces measured after an extrusion distance of 22 mm, 24 mm, 26 mm, and 28 mm. After an extrusion distance of 30 mm, measurement was halted.

For the determination of tack-free time (TFT), several grams of the composition were applied to a cardboard in a thickness of about 2 mm and the time was determined until no more residues were left the first time on the surface of the pipette when tapping the surface of the composition with a LDPE pipette.

For the determination of the adhesion, beads of adhesive of the compositions produced were applied to the corresponding substrates, exposed to different storage conditions, and thereafter tested at room temperature (23° C.) and 50% relative humidity by means of the “bead test”. This test involves incising the bead at the end just above the bond area. The incised end of the bead is held with rounded-end tweezers and pulled from the substrate. This is done by carefully rolling up the bead onto the tip of the tweezers, and placing a cut at right angles to the direction of bead pulling, down to the bare substrate. The bead pulling rate should be selected such that a cut has to be made approximately every 3 seconds. The test distance must be at least 8 cm. After the bead has been pulled off, adhesive remaining on the substrate is assessed (cohesive fracture). The adhesion properties are evaluated by estimation of the cohesive component of the adhesive surface (greater cohesive component denotes better adhesion):

1=>95% cohesive fracture

2=75-95% cohesive fracture

3=25-75% cohesive fracture

4=<25% cohesive fracture

5=0% cohesive fracture (purely adhesive fracture)

The storage conditions for the adhesion experiments were 7 days at 23° C. and 50% relative humidity, followed by immersing in water to store 7 days after examining the adhesion condition; then taking out to examine the adhesion condition, followed by further storing at 80° C. for 1 day and then cooling to room temperature to examine the adhesion condition; further followed by placing in an environment of 70° C. and 90% relative humidity for 7 days and then cooling to room temperature to examine the adhesion condition. For each adhesion condition, evaluation was made in accordance with the above standards. The evaluation results are listed in the Table and divided by “/”.

Substrates (adhesion bases) used for the adhesion experiments described above were the following glass or ceramic-coated glass materials: automotive window glass with ceramic coating, type Ferro 3402 (“Ferro 3402”), with ceramic coating, type Ferro 14251 (“Ferro 14251”) and with ceramic coating, type Ferro 14279 (“Ferro 14278”), and also float glass, bonded on the air side (“glass air”), and float glass, bonded on the tin side (“glass tin”). All of these adhesion bases are available from Rocholl GmbH, Germany.

For the determination of initial bonding strength, the prepared composition was applied to a 40*100*6 mm glass sheet by an 8*10 mm triangle adhesive nozzle. Within five minutes, another glass sheet of the same size was overlapped on the first glass sheet under pressure, with the adhesive thickness controlled at 5±1 mm and the adhesive width controlled at 9±2 mm. The sample was placed in an environment of 23° C. and 50% relative humidity for 4 hours. A Zwick/Roell Z005 device with a corresponding mold was used to separate the two glass sheets at a speed of 200 mm/min. The measured value of force per unit length was the initial bonding strength.

The test method for the amount of TVOC may be conducted by referring to Test Standard for Volatile Organics in Non-metallic Materials in Automobile Internal Decoration VDA277.

The anti-sliding property of the composition was determined as follows: Two glass sheets having a size of 100×40×6 mm (weight about 60 g) were prepared with the glass surfaces treated by using Sika Activator100N. A 8*10 mm triangle adhesive nozzle was used to apply a triangle adhesive strip having a length of 8-10 mm on a tape. After 30s, the prepared glass sheets were bonded at the edges of the surfaces of the triangle adhesive stripe. A compressed air device was used to horizontally press the glass sheets against the adhesive stripe tightly with a distance between the glass and the tape kept at 5 mm, so that the width of the adhesive stripe can be controlled at from 9 to 11 mm. The lower end of the point of a height gauge (Sony U30A) was in touch with the upper side of the glass, and the displayed number was set to 0. The lower edge of the glass was held up by a holder. Test time was set at two minutes, and the compressed air was released to suspend the lower edge of the glass in the air. Timing was started, and the distance slid by the glass (in mm) was recorded in two minutes.

To test anti-sagging property, the composition was applied by a 8*20 mm adhesive nozzle on a vertical plane to form a triangle adhesive stripe in a horizontal direction. After placing for 2 to 3 minutes, the sagging profile of the adhesive stripe tip was observed. The standard for determining sagging property was as follows:

1—tip having no move;

2—tip sagging to the middle of the initial triangle apex and the perpendicular line of lower apex angle;

3—tip sagging to the height of the perpendicular line of triangle's lower apex angle;

4—tip sagging to below the perpendicular line of lower apex angle;

5—no tips.

To test Shore A hardness, the composition was applied to a mold having an internal diameter of about 42 mm and a thickness about 6 mm, and placed in the environment of 23VC and 50% relative humidity for 7 days. The sample's surface was tested by HPE II (Zwick) Thickness Test Instrument. Test was made on at least three points on the surface, which points were at least 6 to 12 mm away from the edge.

Raw Materials

The following materials were used in the examples:

| Names or Abbr. | Remarks | Origins |
|---|---|---|
| 330N | EO terminated polyether | Jia Hua Chemicals |
| | triols (average molecular | |
| | weight about 5,000 g/mol) | |
| JH-240 | PO terminated polyether | Jia Hua Chemicals |
| | diol (average molecular | |
| | weight about 4,000 g/mol) | |
| GY-4000 | PO terminated polyether | Kukdo Chemical |
| | triols (average molecular | |
| | weight about 4,000 g/mol) | |
| Desmodur T80 | tolylene diisocyanate | Covestro |
| Desmodur 44C | 4,4-diphenylmethane | Covestro |
| | diisocyanate | |
| Baycoll AD 2055 | Polyester diol (average | Covestro |
| | molecular weight about | |
| | 2,000 g/mol) | |
| Omyacarb 10-QY | Surface treated calcium | Omya |
| | carbonate | |
| Monarch M570 | Carbon black | Cabot |
| DIDP | Diisodecyl phthalate | Formosa Chemical |
| Silquest ®A-187 ™ | Glycidoxypropyl | Momentive |
| | trimethoxy silane | |
| DBTDL | Dibutyltin dilaurate | Nanjing Dingxin New |
| | | Materials and |
| | | Technology Ltd. |
| Dabco33LV | 33% solution of triethylene | Air Products, US |
| | diamine in dipropylene | |
| | glycol | |

Preparation of Component Comprising Polyurethane Prepolymers PU-1

Desmodur 44C was placed in a baking oven at 70° C. for 2 hours. A glass reaction vessel was placed on an electric heating mantle. Under the protection of nitrogen, 300 g of 330N and a plasticizer DIDP were added, and heated to 50° C. 45 g of Desmodur 44C was added at a molar ratio of NCO:OH of 2.1:1. After agitating for 5 minutes, 0.04 g of catalyst Dabco33LV was added and further heated to 80° C. when timing was started. After 1 hour, NCO content was measured. The reaction was stopped when the measured value was close to the set value.

Preparation of Component Comprising Polyurethane Prepolymers PU-2

Desmodur 44C was placed in a baking oven at 70° C. for 2 hours. A glass reaction vessel was placed on an electric heating mantle. Under the protection of nitrogen, 300 g of Baycoll AD 2055, 100 g of JH-240 and a plasticizer DIDP were added and heated to 50° C. Desmodur 44C was added. After agitating for 5 minutes, 0.04 g of catalyst Dabco33LV was added and further heated to 80° C. when timing was started. After 1 hour, NCO content was measured. The reaction was stopped when the measured value was close to the set value.

Preparation of Polyurethane Prepolymers PU-R1

Desmodur 44C was placed in a baking oven at 70° C. for 2 hours. A glass reaction vessel was placed on an electric heating mantle. Under the protection of nitrogen, 300 g of GY-4000 and a plasticizer DIDP were added, and heated to 50° C. 56 g of Desmodur 44C was added at a molar ratio of NCO:OH of 2.1:1. After agitating for 5 minutes, 0.04 g of catalyst Dabco33LV was added and further heated to 80° C. when timing was started. After 1 hour, NCO content was measured. The reaction was stopped when the measured value was close to the set value.

Preparation of TDI Prepolymer

A glass reaction vessel was placed on an electric heating mantle. Under the protection of nitrogen, 38 g of Desmodur T80, 311 g of JH-240, 130 g of GY-4000 and a plasticizer DIDP were added and heated to 50° C. After agitating for 5 minutes, 0.04 g of catalyst Dabco33LV was added and further heated to 80° C. when timing was started. After 1 hour, NCO content was measured. The reaction was stopped when the measured value was close to the set value.

Formulation of the Compositions

A step-by-step mixing method was used to prepare compositions 1 to 4 and reference compositions R1 to R5: in a first step, polyurethane prepolymer, plasticizer DIDP, calcium carbonate Omyacarb 10-QY and carbon black Monarch M570 were added and mixed at 400 rpm for 15 minutes at 60° C.; in a second step, at the temperature set at room temperature (about 23° C.), silane coupling agent Silquest®A-187™ was added and mixed at 350 rpm for 5 minutes; and finally, the tin catalyst DBTDL was added and mixed at 300 rpm for 10 minutes to the end. The whole mixing process was protected under vacuum. The make-ups of each composition are shown in Table 1 below, wherein % means weight percent.

TABLE 1
Make-up of the Compositions

| | Content (%) | | | | | | | | |
|---|---|---|---|---|---|---|---|---|---|
| Main ingredients | 1 | R1 | R2 | R3 | R4 | R5 | 2 | 3 | 4 |
| Polyurethane | 28 | 0 | 28 | 18 | 36 | 22.4 | 32 | 24 | 24 |
| prepolymers PU-1 | | | | | | | | | |
| Polyurethane | 1.4 | 1.4 | 0 | 1.4 | 1.4 | 3.5 | 1.4 | 0.35 | 2.1 |
| prepolymers PU-2 | | | | | | | | | |
| Polyurethane | 0 | 27 | 0 | 0 | 0 | 0 | 0 | 0 | 0 |
| prepolymers | | | | | | | | | |
| PU-R1 | | | | | | | | | |
| TDI prepolymer | 5 | 5 | 5 | 15 | 0 | 5 | 0 | 5 | 5 |
| Omyacard 10-QY | 25.6 | 25.6 | 27.6 | 25.6 | 20 | 24 | 30 | 27 | 24.6 |
| DIDP | 20 | 20 | 20 | 20 | 15.6 | 20.6 | 10.6 | 20 | 20 |
| Monarch M570 | 17 | 17 | 17 | 17 | 17 | 17 | 17 | 17 | 17 |
| Silquest ® A-187 ™ | 0.4 | 0.4 | 0.4 | 0.4 | 0.4 | 0.4 | 0.4 | 0.4 | 0.4 |
| DBTCL | 0.01 | 0.01 | 0.01 | 0.01 | 0.01 | 0.01 | 0.01 | 0.01 | 0.01 |

Results of Property Tests

The prepared compositions were tested in regard to various properties in accordance with the above described test methods. The results are shown in Table 2.

TABLE 2
The results tested for each composition

| Properties | 1 | R1 | R2 | R3 | R4 | R5 | 2 | 3 | 4 |
|---|---|---|---|---|---|---|---|---|---|
| TVOC [μgC/g] | 36 | n.d. | n.d. | n.d. | n.d. | n.d. | n.d. | n.d. | n.d. |
| Tensile | 4.75 | 5.0 | 4.5 | 2.5 | 5.0 | 4.2 | 5.0 | 4.4 | 4.7 |
| strength [MPa] | | | | | | | | | |
| Elongation at | 575% | 610% | 550% | 580% | 480% | 550% | 410% | 560% | 550% |
| break [%] | | | | | | | | | |
| Initial bonding | 63 | 37 | 40 | 30 | 55 | 58 | 56 | 51 | 58 |
| strength [N/cm] | | | | | | | | | |
| Shore A | 49 | 54 | 46 | 40 | 61 | 56 | 57 | 49 | 51 |
| hardness | | | | | | | | | |
| Extrusion force | 454 | 329 | 350 | 420 | 420 | 620 | 406 | 374 | 440 |
| (5 mm) [N] | | | | | | | | | |
| Tack free time | 29 | 51 | 28 | 35 | 20 | 27 | 22 | 27 | 28 |
| [min] | | | | | | | | | |
| Anti-sagging | 1 | 1 | 3 | 1 | 1~2 | 1 | 1 | 1~2 | 1 |
| property | | | | | | | | | |
| Anti-sliding | 0.32 | 1.01 | 2.4 | 0.3 | 1.8 | 0 | 0.9 | 1.8 | 0.3 |
| property (mm) | | | | | | | | | |
| Float glass | 1/1/1/ | 2/3/1/ | 2/1/1/ | 1/1/1/ | 1/1/1/ | 1/1/1/ | 1/1/1/ | 1/1/1/ | 1/1/1/ |
| (air side) | 1 | 1 | 1 | 1 | 1 | 1 | 1 | 1 | 1 |
| High | 1/1/1/ | 2/2/1/ | 1~2/ | 1/1/1/ | 2/2/1/ | 1/1/1/ | 1/1/1/ | 1/1/1/ | 1/1/1/ |
| temperature | 1 | 1 | 1/1/1 | 1 | 1 | 1 | 1 | 1 | 1 |
| baked ink glass | | | | | | | | | |

n.d. = not determined

1. A polyurethane composition, comprising, based on the total weight of the composition,
A) 20-35 wt % of polyurethane prepolymer PU-1 which is a reaction product of ethylene oxide (EO)-terminated polyether triol with an aromatic polyisocyanate, and
B) 0.2-3 wt % of polyurethane prepolymer PU-2 which is a reaction product of polyester polyol with an aromatic polyisocyanate.

2. The polyurethane composition according to claim 1, wherein the aromatic polyisocyanate is a diisocyanate which is selected from m- and p-xylylene diisocyanate (m- and p-XDI), m- and p-tetramethyl-1,3-xylylene diisocyanate, m- and p-tetramethyl-1,4-xylylene diisocyanate, bis(1-Isocyanato-1-methylethyl)naphthalene, 2,4- and 2,6-tolylene diisocyanate (TDI), 4,4′-, 2,4′- and 2,2′-diphenylmethane diisocyanate (MDI), 1,3- and 1,4-phenylene diisocyanate, 2,3,5,6-tetramethyl-1,4-diisocyanatobenzene, naphthalene 1,5-diisocyanate (NDI), 3,3′-dimethyl-4,4′-diisocyanatodiphenyl (TODI), oligomers and mixtures of the aforesaid isocyanates.

3. The polyurethane composition according to claim 1, wherein the polyether triol is selected from polyoxyethylene triol, polyoxypropylene triol and/or polyoxypropylene polyoxyethylene triol.

4. The polyurethane composition according to claim 1, wherein the molecular weight of said ethylene oxide-terminated polyether triol ranges from 4000 to 6000 g/mol.

5. The polyurethane composition according to claim 1, wherein the molecular weight of the polyester polyol ranges from 1000 to 4000 g/mol.

6. The polyurethane composition according to claim 1, wherein polyester polyol is a polyester diol and is hydrophobic.

7. The polyurethane composition according to claim 1, wherein the composition further comprises a reaction product of polyether polydiol and polyethertriol, which are not terminated by ethylene oxide, with an aromatic polyisocyanate in an amount of less than 20 wt %.

8. The polyurethane composition according to claim 7, wherein the molecular weight of non-EO-terminated polyether diol ranges from 2800 to 4500 g/mol and the molecular weight of non-EO-terminated polyether triol ranges from 3500 to 6000 g/mol.

9. The polyurethane composition according to claim 1, wherein it comprises at least one further constituent selected from fillers, crosslinkers, plasticizers, solvents, catalysts, adhesion promoters, desiccants, stabilizers, pigments and rheology aids.

10. The polyurethane composition according to claim 1, wherein it comprises less than 1 wt % of organic solvent, based on the total weight of the composition.

11. A cured composition as obtained after curing the composition according to claim 1.

12. A method of bonding substrates, including:
a) applying the composition according to claim 1 to a first substrate;
b) providing a second substrate on which the composition is optionally applied; and
c) contacting the first and second substrate;
wherein the first and second substrates are made from the same or different materials.

13. The method according to claim 12, wherein the first and second substrates are the same or differently selected from glass, ceramic and transportation vehicles and the components thereof.

14. A product obtained by the method according to claim 12.
